(19) United States
(12) Patent Application Publication
(10) Pub. No.: US 2015/0342412 A1
(43) Pub. Date: Dec. 3, 2015

(54) Multifunctional Kitchen Tool

(71) Applicant: Mirwais Noorzai, Centennial, CO (US)

(72) Inventor: Mirwais Noorzai, Centennial, CO (US)

(21) Appl. No.: 14/724,013

(22) Filed: May 28, 2015

Related U.S. Application Data
(60) Provisional application No. 62/006,558, filed on Jun. 2, 2014.

(51) Int. Cl. A47J 43/28; B26B 11/00; B67B 7/44

(52) U.S. Cl. CPC A47J 43/288; B67B 7/44; B26B 11/008; B26B 11/001

(57) ABSTRACT

A multifunctional kitchen tool is a device that provides a plurality of retractable tools, a plurality of foldaway tools, and a plurality of detachable tools for performing various kitchen-related activities. A plurality of tool-receiving slots, a plurality of tool trenches, a first recessed space, and a second recessed space are provided on a handle body for housing the tools. The device features a food thermometer, a peeler, a corkscrew, a bottle opener, a spring-loaded grater, a spring-loaded knife sharpener, a spring-loaded spatula, and a spring-loaded knife. The tools may be deployed from the handle body when needed and folded or retracted into the handle body when not in use. The plurality of detachable tools is externally mounted to the handle body and is removable from the device for cleaning or other maintenance purposes.

The current application claims a priority to the U.S. Provisional Patent application Ser. No. 62/006,558 filed on Jun. 2, 2014.

### FIELD OF THE INVENTION

The present invention relates generally to a multi-tool device primarily for use in kitchen-related applications. More specifically, the present invention is a multifunctional kitchen tool that facilitates various kitchen-related tasks. The present invention maintains multiple kitchen utensils and tools close at hand and integrated into a single device.

### BACKGROUND OF THE INVENTION

When cooking, a large portion of the cooking process is consumed by the preparation of ingredients and the monitoring of cooking food. A wide variety of utensils and other tools are often needed to perform various tasks during the cooking process. A crowded and unorganized cooking space can create difficulties in locating the utensils or tools that are needed for various tasks. Oftentimes, these utensils and tools are completely unrelated to each other. For example, an individual may need to check the temperature of cooking meat with a food thermometer while in the process of peeling potatoes. As such, misplaced or difficult to find utensils and tools can significantly lengthen the cooking process. In addition to overly complicating the cooking process, a large number of accumulated kitchen utensils and tools can create storage and maintenance issues, as well as a host of other cost and time-related issues.

The present invention is a multifunctional kitchen tool that incorporates a wide variety of kitchen utensils and tools in a single tool for user convenience and accessibility. The present invention is reflective of the diversity of functional requirements of kitchen utensils and tools when cooking. As such, the present invention allows the user to deploy the utensil or tool that he or she requires with the other utensils and tools remaining easily accessible and deployable.

### BRIEF DESCRIPTION OF THE DRAWINGS

FIG. 1 is a perspective view of the present invention in a deployed configuration.

FIG. 2 is an additional perspective view of the present invention in a deployed configuration.

FIG. 3 is a schematic diagram of the electronic components of the present invention.

FIG. 4 is a perspective view of the present invention in a retracted configuration.

FIG. 5 is a front view of the present invention in a retracted configuration.

FIG. 6 is an exploded perspective view of the present invention in a deployed configuration.

### DETAIL DESCRIPTIONS OF THE INVENTION

All illustrations of the drawings are for the purpose of describing selected versions of the present invention and are not intended to limit the scope of the present invention.

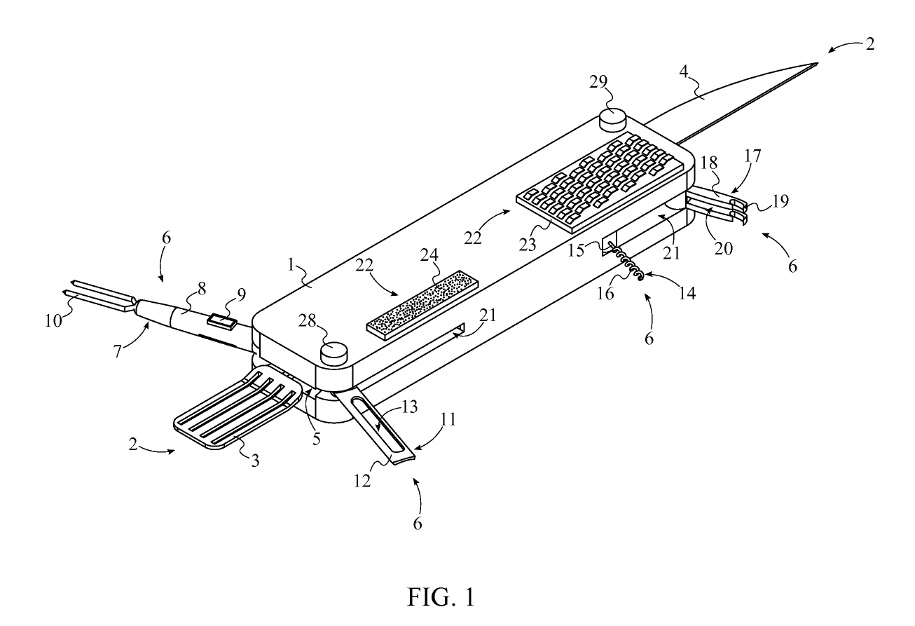

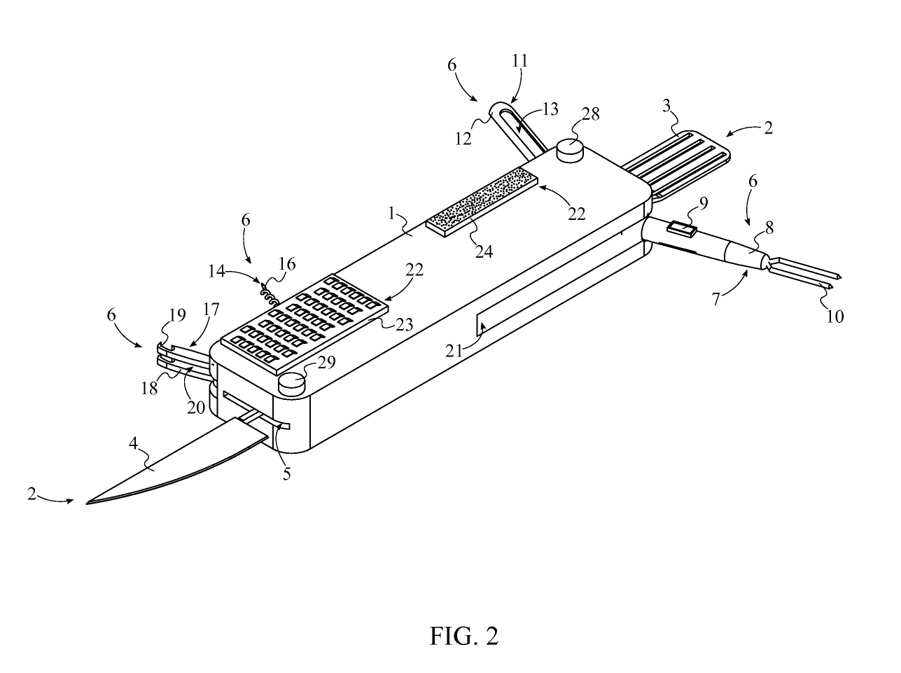

The present invention is a multifunctional kitchen tool for performing various kitchen-related activities. As shown in FIG. 1 and FIG. 2, in its preferred embodiment, the present invention comprises a handle body 1, a plurality of retractable tools 2, a plurality of tool-receiving slots 5, a plurality of foldaway tools 6, a plurality of tool trenches 21, and a plurality of detachable tools 22. The plurality of retractable tools 2, the plurality of foldaway tools 6, and the plurality of detachable tools 22 are deployable in a manner such that the user is able to easily grasp the handle body 1 when utilizing the present invention.

The handle body 1 is the component of the present invention that holds the plurality of retractable tools 2, the plurality of foldaway tools 6, and the plurality of detachable tools 22 as well as the component from which the aforementioned tools are deployed. The plurality of retractable tools 2, the plurality of foldaway tools 6, and the plurality of detachable tools 22 are deployable from the handle body 1 as needed and returned to the handle body 1 after use. The plurality of tool-receiving slots 5 and the plurality of tool trenches 21 are able to accommodate the plurality of retractable tools 2 and the plurality of foldaway tools 6 within the handle body 1 when the plurality of retractable tools 2 and the plurality of foldaway tools 6 are not in use. The plurality of detachable tools 22 is removable from the handle body 1 for cleaning or other maintenance purposes.

The plurality of tool-receiving slots 5 laterally traverses into the handle body 1, allowing the plurality of retractable tools 2 to be laterally deployed from the handle body 1 as well as laterally retracted into the handle body 1. The lateral positioning of the plurality of tool-receiving slots 5 allows the user to easily grasp and manipulate the handle body 1 when the present invention is in use. Each of the plurality of retractable tools 2 is slidably engaged into a corresponding slot from the plurality of tool-receiving slots 5. As such, each of the plurality of retractable tools 2 is housed in and deployed from its own corresponding slot. In the preferred embodiment of the present invention, the plurality of retractable tools 2 is two individual tools that are deployed from corresponding slots located at opposite ends of the handle body 1. Similar to the plurality of tool-receiving slots 5, the plurality of tool trenches 21 laterally traverses into the handle body 1, aiding the user's grasp of the handle body 1 when the present invention is in use. The plurality of tool trenches 21 is perpendicularly and adjacently positioned to the plurality of tool-receiving slots 5 and, as such, in the preferred embodiment of the present invention, the plurality of tool trenches 21 is positioned along the length of the handle body 1. Each of the plurality of foldaway tools 6 is hingedly mounted within a corresponding trench from the plurality of tool trenches 21. This allows the plurality of foldaway tools 6 to be folded into or folded out of the handle body 1 as needed. The plurality of detachable tools 22 is externally mounted to the handle body 1, adjacent to both the plurality of foldaway tools 6 and the plurality of retractable tools 2. The external positioning of the plurality of detachable tools 22 facilitates removal of the plurality of detachable tools 22 from the handle body 1.

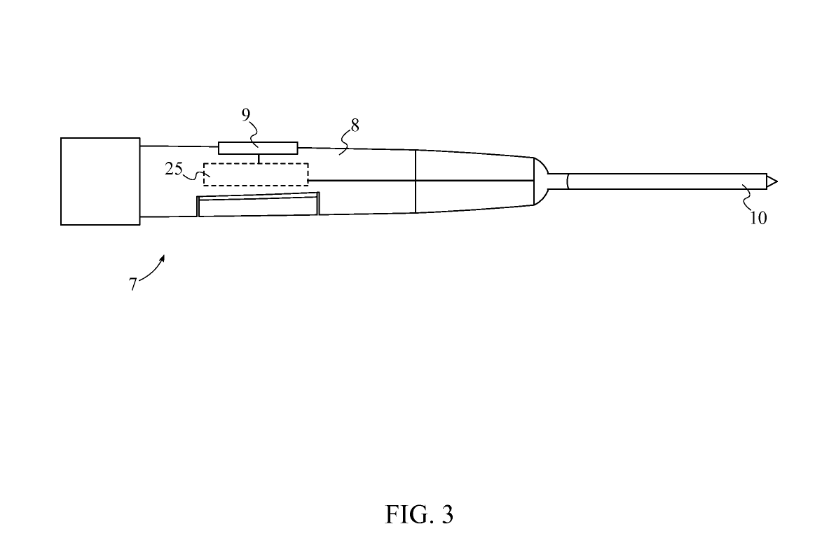

Again with reference to FIGS. 1-3, the plurality of foldaway tools 6 comprises a food thermometer 7. The food thermometer 7 comprises a thermometer body 8, a screen 9, a probe 10, and a portable power supply 25. The food thermometer 7 is used to measure the temperature of various foods (e.g. cooking meats). In the preferred embodiment of the present invention, the portable power supply 25 is a replaceable battery and provides power to the screen 9 and to the probe 10. The thermometer body 8 is the component that houses the internal electronic components of the food thermometer 7. The screen 9 visibly outputs a measured food temperature for the user. The probe 10 is the temperature-measuring device that is inserted into food in order to measure the food's temperature. The probe 10 is mounted adjacent to the thermometer body 8 while the thermometer body 8 is hingedly mounted into the corresponding trench, opposite to the probe 10. This positioning places the probe 10 away from the handle body 1 when the food thermometer 7 is deployed, facilitating the insertion of the probe 10 into the food in order to measure temperature. The portable power supply 25 is enclosed within the thermometer body 8, positioning the portable power supply 25 away from the exterior environment and from any potential damage. In the preferred embodiment of the present invention, the portable power supply 25 may be accessed via a removable door or hatch. The screen 9 is laterally and externally mounted on the thermometer body 8. The external positioning of the screen 9 facilitates reading the output temperature on the screen 9. The screen 9 and the probe 10 are electrically connected to the portable power supply 25, allowing the portable power supply 25 to provide power to both the screen 9 and the probe 10.

Again with reference to FIG. 1 and FIG. 2, the plurality of foldaway tools 6 further comprises a peeler 11. The peeler 11 is utilized to remove the outer skin or peel of various vegetables and fruits. The peeler 11 comprises an elongated blade 12 and a slot 13. The elongated blade 12 is the component that is placed into contact with the vegetable or fruit during the peeling process. The elongated blade 12 is hingedly mounted into the corresponding trench, allowing the elongated blade 12 to be folded away into the handle body 1 when not in use. The slot 13 longitudinally traverses through the elongated blade 12. The slot 13 is able to cut into and peel the outer skin or peel of the vegetable or fruit. In the preferred embodiment of the present invention, the slot 13 is sharpened in order to facilitate removal of the outer skin or peel of the vegetable or fruit. The slot 13 additionally prevents the elongated blade 12 from cutting too deeply into the vegetable or fruit.

The plurality of foldaway tools 6 further comprises a corkscrew 14 and a bottle opener 17. The corkscrew 14 is utilized to extract a cork from a bottle while the bottle opener 17 enables the removal of a bottle cap that is not easily removed by hand. The corkscrew 14 comprises a stem portion 15 and a helical screw portion 16. The stem portion 15 is connected in between the helical screw portion 16 and a corresponding trench and as such, the stem portion 15 serves to connect the helical screw portion 16 to the handle body 1. The helical screw portion 16 is connected adjacent to the stem portion 15, positioning the helical screw portion 16 away from the corresponding trench and allowing the helical screw portion 16 to be screwed into a cork during removal of the cork. The stem portion 15 is hingedly mounted within the corresponding trench, allowing the corkscrew 14 to be folded away into the handle body 1 when not in use. The bottle opener 17 comprises an opener body 18 and a leveraging portion 19. The opener body 18 may be grasped by the user and is sufficiently rigid to maintain structural integrity of the bottle opener 17 when a bottle cap is being removed. The leveraging portion 19 is the component that is placed into contact with a bottle cap and exerts the force required to remove the bottle cap. The leveraging portion 19 is connected adjacent to the opener body 18, allowing the user to grasp the opener body 18 and exert the force required to remove the bottle cap. The opener body 18 is hingedly mounted within the corresponding trench, opposite to the leveraging portion 19. As such, the bottle opener 17 may be folded away into the handle body 1 when not in use.

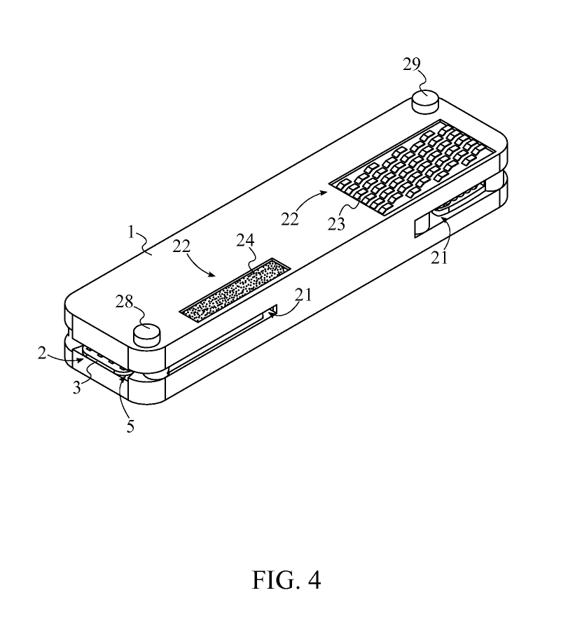

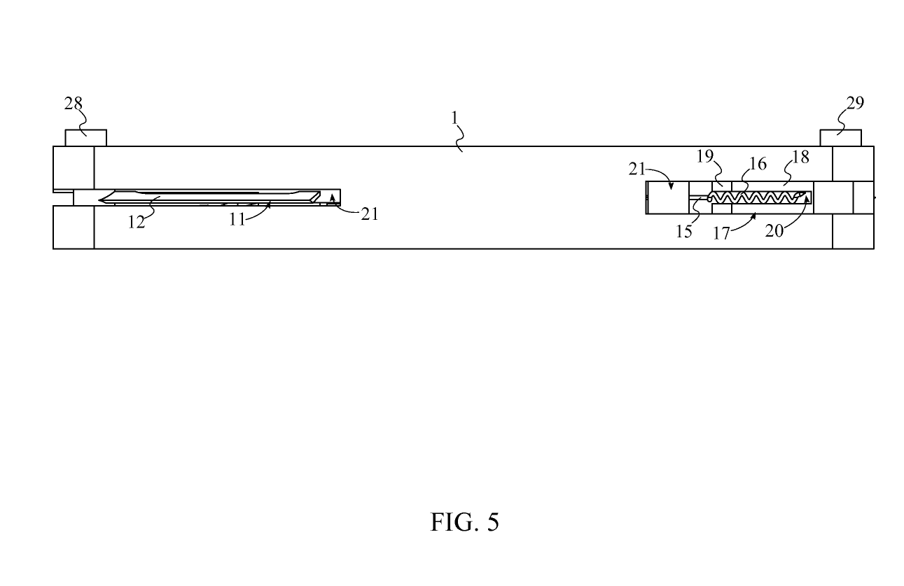

Because the corkscrew 14 and the bottle opener 17 are utilized for similar purposes in opening a beverage container, in the preferred embodiment of the present invention, the hinged connection between the stem portion 15 and the corresponding trench and the hinged connection between the opener body 18 and the corresponding trench are positioned opposite to each other along the corresponding trench. This places the corkscrew 14 and the bottle opener 17 within the same corresponding trench. The corkscrew 14 and the bottle opener 17 are shown in a collapsed configuration within the corresponding trench in FIG. 4 and FIG. 5. In the preferred embodiment of the present invention, the bottle opener 17 further comprises a screw-receiving hole 20. The screw-receiving hole 20 is able to accommodate the corkscrew 14 when the corkscrew 14 is folded into the corresponding trench. The screw-receiving hole 20 traverses through the leveraging portion 19 and into the opener body 18. This ensures that the screw-receiving hole 20 is sufficiently sized to accommodate the corkscrew 14 when the corkscrew 14 and the bottle opener 17 are folded into the corresponding trench. In the collapsed configuration, the bottle opener 17 is positioned within the corresponding trench and the corkscrew 14 is positioned within the screw-receiving hole 20. This configuration provides sufficient clearance for both the bottle opener 17 and the corkscrew 14 within the corresponding trench.

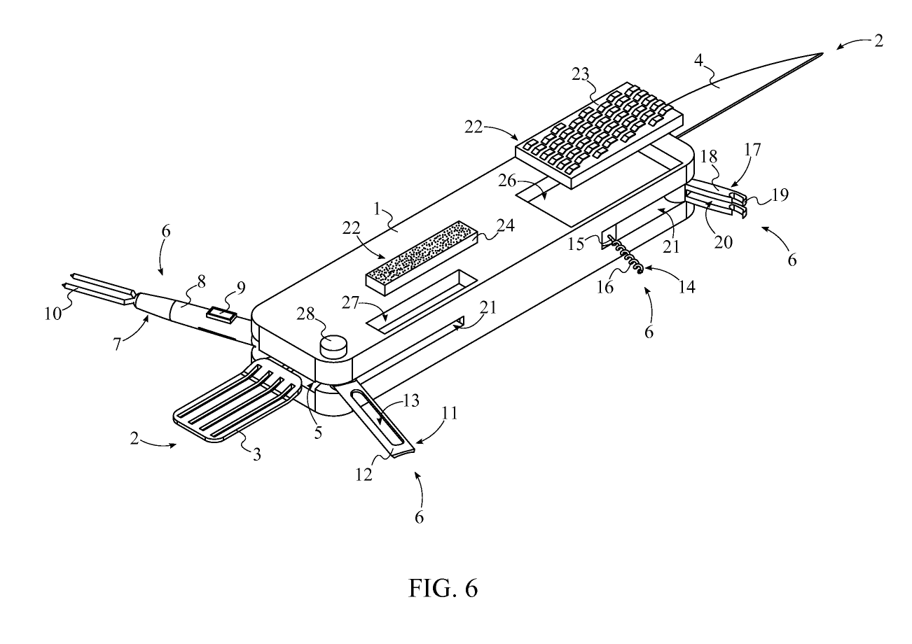

As shown in FIG. 6, the present invention further comprises a first recessed space 26. In the preferred embodiment of the present invention, the plurality of detachable tools 22 comprises a spring-loaded grater 23. The spring-loaded grater 23 is utilized to grate foods such as cheese or vegetables into fine pieces. The first recessed space 26 allows the spring-loaded grater 23 to be mounted into the handle body 1. The first recessed space 26 traverses into the handle body 1 in order to position the spring-loaded grater 23 external to the handle body 1 when in use and within the first recessed space 26 within the handle body 1 when not in use. The spring-loaded grater 23 is retractably and bistably mounted into the first recessed space 26. As such, in the preferred embodiment of the present invention, the spring-loaded grater 23 may be pressed into the first recessed space 26 in order to deploy the spring-loaded grater 23 on the exterior of the handle body 1. The spring-loaded grater 23 is pressed again to retract the spring-loaded grater 23. The spring-loaded grater 23 is locked into place once deployed or retracted and may be unlocked by pressing the spring-loaded grater 23.

The present invention further comprises a second recessed space 27. Additionally, the plurality of detachable tools 22 comprises a spring-loaded knife sharpener 24. The spring-loaded knife sharpener 24 is utilized to sharpen the blades of kitchen knives and similar utensils or tools. The second recessed space 27 functions in the same manner as the first recessed space 26 and allows the spring-loaded knife sharpener 24 to be mounted into the handle body 1. Much like the first recessed space 26, the second recessed space 27 traverses into the handle body 1 in order to position the spring-loaded knife sharpener 24 within the handle body 1 when not in use. The spring-loaded knife sharpener 24 is retractably and bistably mounted into the second recessed space 27. As with the spring-loaded grater 23, the spring-loaded knife sharpener 24 may be pressed in order to deploy the spring-loaded knife sharpener 24 on the exterior of the handle body 1. The spring-loaded knife sharpener 24 is pressed again to retract the spring-loaded knife sharpener 24. The spring-loaded knife sharpener 24 is locked into place once deployed or retracted as well, much like the spring-loaded grater 23. The spring-loaded knife sharpener is unlocked by pressing the spring-loaded sharpener 24.

Again referring to FIG. 1, FIG. 2, and FIGS. 4-6, in its preferred embodiment, the present invention further comprises a first trigger button 28. Additionally, the plurality of retractable tools 2 comprises a spring-loaded spatula 3. The first trigger button 28 is utilized to deploy as well as retract the spring-loaded spatula 3. The spring-loaded spatula 3 is utilized to handle various types of foods. The spring-loaded spatula 3 is tensionably connected within the corresponding slot, thus allowing the spring-loaded spatula 3 to be deployed from the corresponding slot and held in place during use. Additionally, the spring-loaded spatula 3 may be retracted into the handle body 1 and held in place when not in use. The spring-loaded spatula 3 is longitudinally oriented with the corresponding slot. This allows the user to grasp the handle body 1 when utilizing the spring-loaded spatula 3 to handle food. The spring-loaded spatula 3 is slidably engaged into the corresponding slot and as such, the spring-loaded spatula 3 is able to slide unimpeded within the corresponding slot during deployment and retraction. The first trigger button 28 is mechanically integrated between the spring-loaded spatula 3 and the corresponding slot. As such, when the first trigger button 28 is actuated, the spring-loaded spatula 3 is deployed from the corresponding slot and locked in place for use. The first trigger button 28 is actuated again in order to retract the spring-loaded spatula 3 into the corresponding slot. The first trigger button 28 is integrated onto the handle body 1 in order to allow the user to easily deploy and retract the spring-loaded spatula 3 when holding the present invention.

In its preferred embodiment, the present invention further comprises a second trigger button 29. The plurality of retractable tools 2 comprises a spring-loaded knife 4 that is deployable and retractable via the second trigger button 29. The spring-loaded knife 4 may be utilized to cut various foods during preparation. Much like the spring-loaded spatula 3, the spring-loaded knife 4 is tensionably connected within the corresponding slot, allowing the spring-loaded knife 4 to be locked in place after being deployed from the corresponding slot. The spring-loaded knife 4 is additionally locked in place after being retracted into the corresponding slot. The spring-loaded knife 4 is longitudinally oriented with the corresponding slot as well. In the preferred embodiment of the present invention, the spring-loaded knife 4 is oriented away from the spring-loaded spatula 3 and as such, the spring-loaded knife 4 is able to deploy opposite to the spring-loaded spatula 3. The user is able to grasp the handle body 1 when utilizing the spring-loaded knife 4. Similar to the spring-loaded spatula 3, the spring-loaded knife 4 is slidably engaged into the corresponding slot, allowing the spring-loaded knife 4 to slide unimpeded within the corresponding slot during deployment and retraction. The second trigger button 29 functions similar to the first trigger button 28 and is mechanically integrated between the spring-loaded knife 4 and the corresponding slot. This allows the second trigger button 29 to be actuated in order to deploy the spring-loaded knife 4 from the corresponding slot and actuated again in order to retract the spring-loaded knife 4 into the corresponding slot. The second trigger button 29 is integrated onto the handle body 1 as well and is positioned in a manner such that the spring-loaded knife 4 is not accidentally deployed. The present invention may additionally comprise a locking safety mechanism for the second trigger button 29 to prevent accidental deployment of the spring-loaded knife 4.

Although the present invention has been explained in relation to its preferred embodiment, it is understood that many other possible modifications and variations can be made without departing from the spirit and scope of the present invention as hereinafter claimed.

What is claimed is:

1. A multifunctional kitchen tool comprises:
a handle body;
a plurality of retractable tools;
a plurality of tool-receiving slots;
a plurality of foldaway tools;
a plurality of tool trenches;
a plurality of detachable tools;
the plurality of tool-receiving slots laterally traversing into the handle body;
each of the plurality of retractable tools being slidably engaged into a corresponding slot from the plurality of tool-receiving slots;
the plurality of tool trenches laterally traversing into the handle body;
the plurality of tool trenches being perpendicularly and adjacently positioned to the plurality of tool-receiving slots;
each of the plurality of foldaway tools being hingedly mounted within a corresponding trench from the plurality of tool trenches; and
the plurality of detachable tools being externally mounted to the handle body adjacent to both the plurality of foldaway tools and the plurality of retractable tools.

2. The multifunctional kitchen tool as claimed in claim 1 further comprises:
the plurality of foldaway tools comprises a food thermometer;
the food thermometer comprises a thermometer body, a screen, a probe, and a portable power supply;
the probe being mounted adjacent to the thermometer body;
the thermometer body being hingedly mounted into the corresponding trench, opposite to the probe;
the portable power supply being enclosed within the thermometer body;
the screen being laterally and externally mounted on the thermometer body; and
the screen and the probe being electrically connected to the portable power supply.

3. The multifunctional kitchen tool as claimed in claim 1 further comprises:
the plurality of foldaway tools comprises a peeler;
the peeler comprises an elongated blade and a slot;
the elongated blade being hingedly mounted into the corresponding trench; and
the slot longitudinally traversing through the elongated blade.

4. The multifunctional kitchen tool as claimed in claim 1 further comprises:
the plurality of foldaway tools comprises a corkscrew and a bottle opener;
the corkscrew comprises a stem portion and a helical screw portion;
the bottle opener comprises an opener body and a leveraging portion;
the stem portion being connected in between the helical screw portion and a corresponding trench;
the helical screw portion being connected adjacent to the stem portion;
the stem portion being hingedly mounted within the corresponding trench;
the leveraging portion being connected adjacent to the opener body; and
the opener body being hingedly mounted within the corresponding trench, opposite to the leveraging portion.

5. The multifunctional kitchen tool as claimed in claim 4, wherein the hinged connection between the stem portion and the corresponding trench and the hinged connection between the opener body and the corresponding trench are positioned opposite to each other along the corresponding trench.

6. The multifunctional kitchen tool as claimed in claim 4 further comprises:
wherein the corkscrew and the bottle opener are in a collapsed configuration within the corresponding trench;
the bottle opener further comprises a screw-receiving hole;
the screw-receiving hole traversing through the leveraging portion and into the opener body;
the bottle opener being positioned within the corresponding trench; and
the corkscrew being positioned within the screw-receiving hole.

7. The multifunctional kitchen tool as claimed in claim 1 further comprises:
a first recessed space;
the plurality of detachable tools comprises a spring-loaded grater;
the first recessed space traversing into the handle body; and
the spring-loaded grater being retractably and bistably mounted into the first recessed space.

8. The multifunctional kitchen tool as claimed in claim 1 further comprises:
a second recessed space;
the plurality of detachable tools comprises a spring-loaded knife sharpener;
the second recessed space traversing into the handle body; and
the spring-loaded knife sharpener being retractably and bistably mounted into the second recessed space.

9. The multifunctional kitchen tool as claimed in claim 1 further comprises:
a first trigger button;
the plurality of retractable tools comprises a spring-loaded spatula;
the spring-loaded spatula being tensionably connected within the corresponding slot;
the spring-loaded spatula being longitudinally oriented with the corresponding slot;
the spring-loaded spatula being slidably engaged into the corresponding slot;
the first trigger button being mechanically integrated between the spring-loaded spatula and the corresponding slot; and
the first trigger button being integrated onto the handle body.

10. The multifunctional kitchen tool as claimed in claim 1 further comprises:
a second trigger button;
the plurality of retractable tools comprises a spring-loaded knife;
the spring-loaded knife being tensionably connected within the corresponding slot;
the spring-loaded knife being longitudinally oriented with the corresponding slot;
the spring-loaded knife being slidably engaged into the corresponding slot;
the second trigger button being mechanically integrated between the spring-loaded knife and the corresponding slot; and
the second trigger button being integrated onto the handle body.

11. A multifunctional kitchen tool comprises:
a handle body;
a plurality of retractable tools;
a plurality of tool-receiving slots;
a plurality of foldaway tools;
a plurality of tool trenches;
a plurality of detachable tools;
the plurality of foldaway tools comprises a food thermometer;
the food thermometer comprises a thermometer body, a screen, a probe, and a portable power supply;
the plurality of tool-receiving slots laterally traversing into the handle body;
each of the plurality of retractable tools being slidably engaged into a corresponding slot from the plurality of tool-receiving slots;
the plurality of tool trenches laterally traversing into the handle body;
the plurality of tool trenches being perpendicularly and adjacently positioned to the plurality of tool-receiving slots;
each of the plurality of foldaway tools being hingedly mounted within a corresponding trench from the plurality of tool trenches;
the plurality of detachable tools being externally mounted to the handle body adjacent to both the plurality of foldaway tools and the plurality of retractable tools;
the probe being mounted adjacent to the thermometer body;
the thermometer body being hingedly mounted into the corresponding trench, opposite to the probe;
the portable power supply being enclosed within the thermometer body;
the screen being laterally and externally mounted on the thermometer body; and
the screen and the probe being electrically connected to the portable power supply.

12. The multifunctional kitchen tool as claimed in claim 11 further comprises:
the plurality of foldaway tools further comprises a peeler;
the peeler comprises an elongated blade and a slot;
the elongated blade being hingedly mounted into the corresponding trench; and
the slot longitudinally traversing through the elongated blade.

13. The multifunctional kitchen tool as claimed in claim 11 further comprises:
the plurality of foldaway tools further comprises a corkscrew and a bottle opener;
the corkscrew comprises a stem portion and a helical screw portion;
the bottle opener comprises an opener body and a leveraging portion;
the stem portion being connected in between the helical screw portion and a corresponding trench;
the helical screw portion being connected adjacent to the stem portion;
the stem portion being hingedly mounted within the corresponding trench;
the leveraging portion being connected adjacent to the opener body; and
the opener body being hingedly mounted within the corresponding trench, opposite to the leveraging portion.

14. The multifunctional kitchen tool as claimed in claim 13, wherein the hinged connection between the stem portion and the corresponding trench and the hinged connection between the opener body and the corresponding trench are positioned opposite to each other along the corresponding trench.

15. The multifunctional kitchen tool as claimed in claim 13 further comprises:
wherein the corkscrew and the bottle opener are in a collapsed configuration within the corresponding trench;
the bottle opener further comprises a screw-receiving hole;
the screw-receiving hole traversing through the leveraging portion and into the opener body;
the bottle opener being positioned within the corresponding trench; and
the corkscrew being positioned within the screw-receiving hole.

16. The multifunctional kitchen tool as claimed in claim 11 further comprises:
a first recessed space;
the plurality of detachable tools comprises a spring-loaded grater;
the first recessed space traversing into the handle body; and
the spring-loaded grater being retractably and bistably mounted into the first recessed space.

17. The multifunctional kitchen tool as claimed in claim 11 further comprises:
a second recessed space;
the plurality of detachable tools comprises a spring-loaded knife sharpener;
the second recessed space traversing into the handle body; and
the spring-loaded knife sharpener being retractably and bistably mounted into the second recessed space.

18. The multifunctional kitchen tool as claimed in claim 11 further comprises:
a first trigger button;
the plurality of retractable tools comprises a spring-loaded spatula;
the spring-loaded spatula being tensionably connected within the corresponding slot;
the spring-loaded spatula being longitudinally oriented with the corresponding slot;
the spring-loaded spatula being slidably engaged into the corresponding slot;
the first trigger button being mechanically integrated between the spring-loaded spatula and the corresponding slot; and
the first trigger button being integrated onto the handle body.

19. The multifunctional kitchen tool as claimed in claim 11 further comprises:
a second trigger button;
the plurality of retractable tools comprises a spring-loaded knife;
the spring-loaded knife being tensionably connected within the corresponding slot;
the spring-loaded knife being longitudinally oriented with the corresponding slot;
the spring-loaded knife being slidably engaged into the corresponding slot;
the second trigger button being mechanically integrated between the spring-loaded knife and the corresponding slot; and
the second trigger button being integrated onto the handle body.
